(19) United States
(12) Patent Application Publication
(10) Pub. No.: US 2006/0196741 A1
(43) Pub. Date: Sep. 7, 2006

(54) Shock absorber for height adjustment

(76) Inventor: Sven Kindblom, Sollentuna (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/547,754

(22) PCT Filed: Mar. 23, 2004
(86) PCT No.: PCT/SE04/00427

§ 371 Date: Sep. 1, 2005

(30) Foreign Application Priority Data
Mar. 25, 2003 (SE) 0300807-5

(51) Int. Cl. F16F 9/00

(52) U.S. Cl. 188/318

(57) ABSTRACT

A shock absorber for controlling the height of vehicles that has a cylinder, a shock absorber piston including a piston rod. The piston rod is slidably mounted in the cylinder and has an end opposite to the piston extending sealingly through a first end of the cylinder, a second end of which is closed, and a shock absorber spring. The shock absorber spring is arranged between the shock absorber piston and a separating piston located at an end of the cylinder. The separating piston is sealingly slidable in relation to the cylinder wall and, together with the end of the cylinder, form a closed control chamber. A gas spring is connected to the control chamber via a shut-off valve.

The present invention is concerned with a shock absorber according to the preamble of claim 1.

In many cases there is a need for enabling in a very easy manner the adjustment of the height of the vehicle over the ground—the road clearance—particularly for motorcycles. The following explanation of the invention is therefore concerned with the height adjustment of a motorcycle.

It is known to adjust or control the height above the ground of motorcycles. The height control is accomplished in such a way that oil or gas is respectively pumped into and allowed to flow back from a cylinder of a shock absorber by means of a pump provided on the motorcycle. Thereby, the shock absorber piston rod will glide to rise or lower the frame of the motorcycle via a suitable link connection to the rear wheel. The medium pumped in is acting ‘behind’ the shock absorber piston resulting in a direct influence on the characteristics of the spring of the shock absorber.

Another way to control the height is simply by screwing on a piston rod arranged for that purpose on the shock absorber. These both systems are laborious and require time-consuming effort that cannot be made instantaneously.

By the present invention, as defined in the characterizing part of claim 1, there is obtained a shock absorber having a height controlling function that allows an automated and instantaneous adjustment of the height position of the motorcycle only by means of the load of the motorcycle, i.e. the weight of the driver, and without influencing the spring characteristics of the shock absorber spring.

Exemplary embodiments of the invention will be closer described with reference to the drawing, wherein

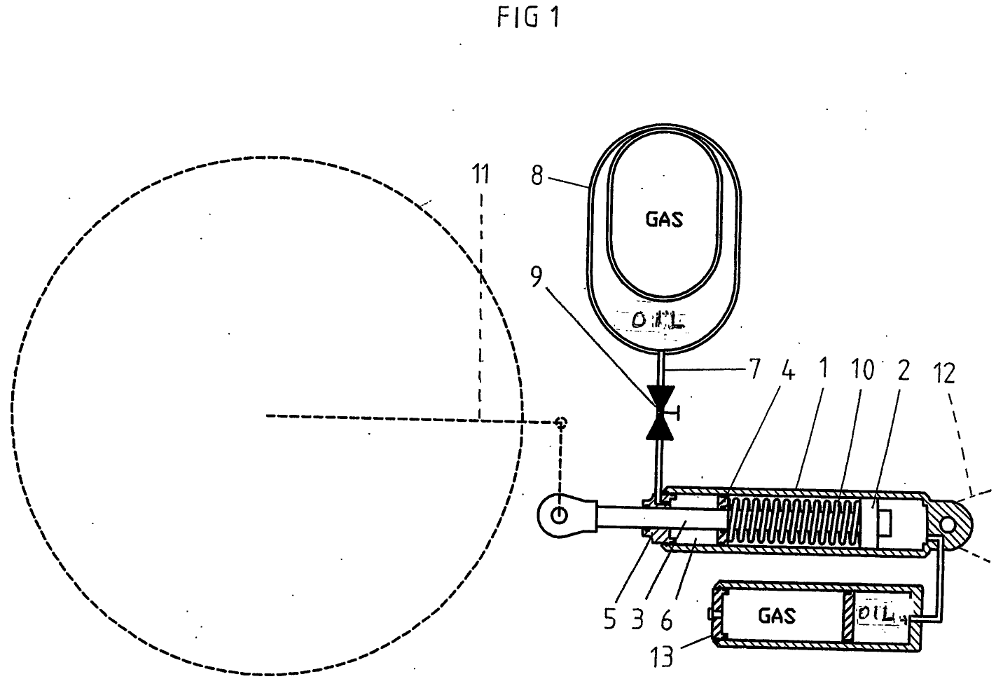

FIG. 1 diagrammatically shows the invention in section and operating with a pulled shock absorber piston; and

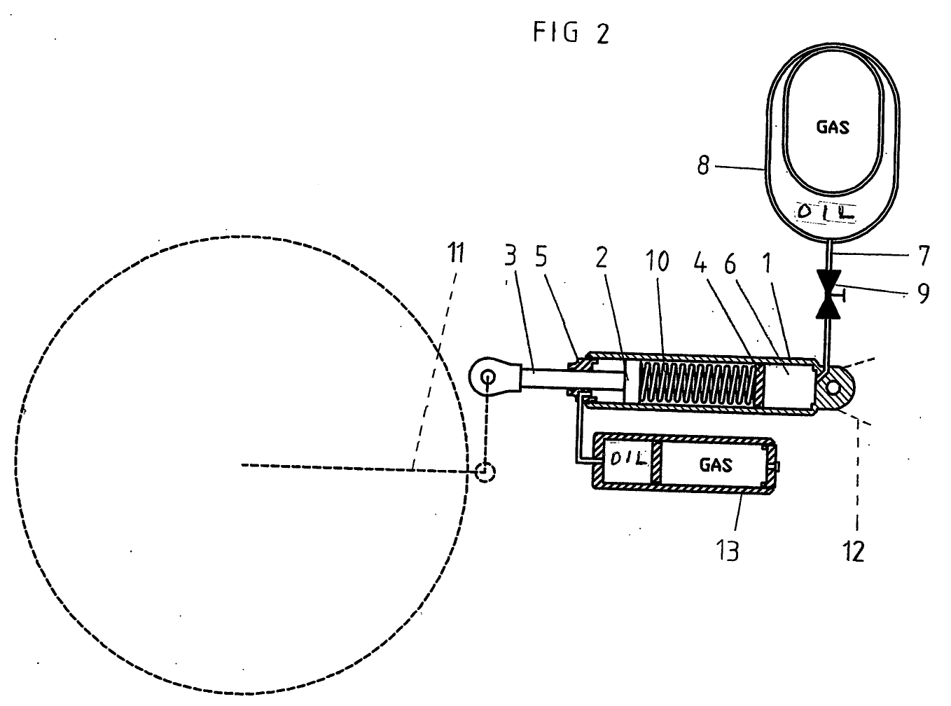

FIG. 2 shows the invention correspondingly but having a pushed shock absorber piston.

In a known manner, the shock absorber piston generally comprises a cylinder 1 and a piston 2 having a piston rod 3. In a conventional manner, the shock absorber piston 2 is designed to have the ability to shock-absorbingly move back and forth in the oil-filled cylinder 1.

According to the invention, a separating piston 4 is arranged ir embodiment shown in FIG. 1, the separating piston 4 is sealing slidably against the cylinder wall and against the piston rod 3 that runs through the separating piston. In FIG. 1, a control chamber 6 is formed between the left end portion 5 of the cylinder 1, which end portion 5 is also sealed against the piston rod 3, and the separating piston 4. Through a line 7, control chamber 6 is in communication with a gas spring 8 which is known per se and is operating by oil or other incompressible medium. Line 7 is provided with a shut-off valve 9. Further, a compression spring 10 is arranged acting, on the one hand, against shock absorber piston 2 and, on the other hand, against separating piston 4. Numeral 13 designates an accumulator which is present at shock absorbers for the purpose of their normal function and will therefore not be further described herein.

The pressure in the gas spring 8 is so controlled that when the motorcycle is unloaded and the valve 9 is open, the pressure is sufficiently large for pushing the separating piston 4 to the right In FIG. 1, pushing piston 2 and piston rod 3 via spring 10 likewise to the right in FIG. 1. The motorcycle thereby acquires its highest ground clearance. If the driver when sitting on the motorcycle wishes to lower the clearance, the valve 9 is opened. Due to the increasing load from the driver on the motorcycle, piston 2 and rod 3 will be moved to the left in FIG. 1. Spring 10 now exerts a pressure on separating piston 4 to the left in FIG. 1. The situation is now that the pressure of gas spring 8 is so controlled that the increasing pressure in control chamber 6 due to the pressure of spring 10 on separating piston 4 is sufficiently large to overcome the action from the gas spring in the control chamber 6, resulting that piston 2 and rod 3 can be displaced to the left in FIG. 1. This position of the piston rod implies that the motorcycle acquires the lowest ground clearance. If the valve 9 is closed in this position, the motorcycle will maintain this ground clearance.

As soon as the motorcycle is unloaded and valve 9 is open, for example by the driver putting his/her feet on the ground and raising, the motorcycle will follow after, i.e. rise to its previous highest ground clearance. Different height positions can be set by closing valve 9 at the acquired height position. In FIG. 1, numeral 11 indicates an angled link arm to be connected to the wheel suspension, and numeral 12 indicates an articulated joint to the motorcycle frame. 11 and 12 constitute expedient measures obvious for the skilled person outside the scope of the invention.

It is to be pointed out that the movements of the separating piston 4 are here relatively small in order to obtain the desired function. It is of course also understood that the spring and shock dampening functions all the time works for different settings of the height positions of the motorcycle, i.e. the positions of the separating piston 4.

FIG. 2 shows a section corresponding to that of FIG. 1 but differing by the piston and rod, instead for being pulled against the action of spring 10 according to FIG. 1, are pushed against the spring that accordingly acts between the shock ab separating piston 4, which is now located to the right in FIG. 2 and which defines the control chamber 6 together with the other end of the cylinder. Thereby the requirement that the piston rod should run through the separating piston 4 is eliminated. Otherwise, also this embodiment functions as that already described in connection with FIG. 1.

It is to be understood that of course also other types of vehicles than motorcycles can make use of the principle described above according to the invention.

1. A shock absorber for controlling the height of vehicles, comprising:
a cylinder (1), a shock absorber piston(2) including a piston rod (C) slidably mounted in the cylinder and having an end opposite to the piston extending sealingly through a first end (5) of the cylinder, a second end of which is closed,
a shock absorber spring (10) being arranged between the shock absorber piston (2) and a separating piston (4) located at an end of the cylinder (1), the separating piston (4) being sealingly slidable in relation to the cylinder wall and, together with the end of the cylinder, forming a closed control chamber (6),
a gas spring (8) being connected to the control chamber (6) via 4 a shut-off valve (9), when a certain load is acting on the piston rod (3) and when the shut-off valve (9) is open, the pressure from the gas spring (8) acting on the separating piston (4) is higher than the pressure from the spring (10) on the separating piston (4), and when a larger load is acting on the piston (3) and thereby on the spring (1C) acting against the separating piston (4}, the pressure in the control chamber (6) is higher than the pressure in the gas spring (8).

2. The shock absorber according to claim 1 wherein the separating piston (4) is located at the first end of the cylinder and is sealingly slidable in relation to the piston rod (3) running sealingly through the separating piston (4).

3. The shock absorber according to claim 1 wherein the separating piston (4) is located at the second end of the cylinder.

4. The shock absorber according to claim 1 wherein the shock absorber is mounted on a motorcycle.
